(19) United States
(12) Patent Application Publication
(10) Pub. No.: US 2022/0318954 A1
(43) Pub. Date: Oct. 6, 2022

(54) REAL TIME MACHINE LEARNING-BASED PRIVACY FILTER FOR REMOVING REFLECTIVE FEATURES FROM IMAGES AND VIDEO

(71) Applicants: Advanced Micro Devices, Inc., Santa Clara, CA (US); ATI Technologies ULC, Markham (CA)

(72) Inventors: Vickie Youmin Wu, Santa Clara, CA (US); Wilson Hung Yu, Markham (CA); Hakki Can Karaimer, Markham (CA)

(73) Assignees: Advanced Micro Devices, Inc., Santa Clara, CA (US); ATI Technologies ULC, Markham (CA)

(21) Appl. No.: 17/219,766

(22) Filed: Mar. 31, 2021

(51) Int. Cl. G06T 5/00; G06K 9/32; H04N 7/15

(52) U.S. Cl. CPC G06T 5/001; G06K 9/3233; H04N 7/15; G06T 2207/10004; G06T 2207/20084; G06T 2207/20081

(57) ABSTRACT

A method for removing reflections from images is disclosed. The method includes identifying one or more segments of an image, the one or more segments including a reflection; identifying one or more features of the one or more segments; removing the one or more features from the segments to generate one or more sanitized segments; and combining the one or more sanitized segments with the image to generate a sanitized image.

### BACKGROUND

Video and image include processing a wide variety of techniques for manipulating data. Improvements to such techniques are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example computing device in which one or more features of the disclosure can be implemented;

FIG. 2 illustrates a system for training one or more neural networks for analyzing video and removing images from reflections, according to an example;

FIG. 3 illustrates a system for analyzing and modifying video to remove reflected images, according to an example;

FIG. 4 is a block diagram illustrating an analysis technique performed by the analysis system, according to an example; and

FIG. 5 is a flow diagram of a method for removing reflections from video or images, according to an example.

### DETAILED DESCRIPTION

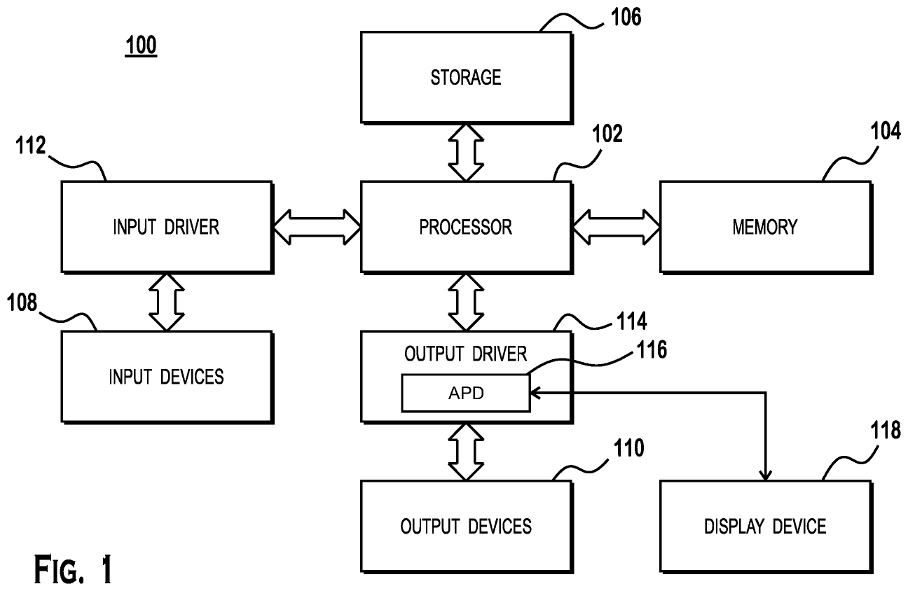

Video data sometimes inadvertently includes private images reflected in a reflective surface such as eyeglasses or mirrors. Techniques are provided herein for removing such private images from video utilizing machine learning. In examples, the techniques include an automated private image removal technique, whereby a device, such as the computing device 100 of FIG. 1 analyzes video data to remove private images. The image removal technique utilizes one or more trained neural networks to perform various tasks for the analysis. In examples, the techniques also include training techniques for training the one or more neural networks for the automated private image removal technique. In various examples, the automated image removal technique is performed by the same computing device 100 or a different computing device 100 as one or more of the training techniques.

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes one or more processors 102, a memory 104, a storage 106, one or more input devices 108, and one or more output devices 110. The device 100 also includes one or more input drivers 112 and one or more output drivers 114. Any of the input drivers 112 are embodied as hardware, a combination of hardware and software, or software, and serve the purpose of controlling input devices 112 (e.g., controlling operation, receiving inputs from, and providing data to input drivers 112). Similarly, any of the output drivers 114 are embodied as hardware, a combination of hardware and software, or software, and serve the purpose of controlling output devices 114 (e.g., controlling operation, receiving inputs from, and providing data to output drivers 114). It is understood that the device 100 can include additional components not shown in FIG. 1.

In various alternatives, the one or more processors 102 include a central processing unit (CPU), a graphics processing unit (GPU), a CPU and GPU located on the same die, or one or more processor cores, wherein each processor core can be a CPU or a GPU. In various alternatives, the memory 104 is located on the same die as one or more of the one or more processors 102, or is located separately from the one or more processors 102. The memory 104 includes a volatile or non-volatile memory, for example, random access memory (RAM), dynamic RAM, or a cache.

The storage 106 includes a fixed or removable storage, for example, without limitation, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 and output driver 114 include one or more hardware, software, and/or firmware components that interface with and drive input devices 108 and output devices 110, respectively. The input driver 112 communicates with the one or more processors 102 and the input devices 108, and permits the one or more processors 102 to receive input from the input devices 108. The output driver 114 communicates with the one or more processors 102 and the output devices 110, and permits the one or more processors 102 to send output to the output devices 110.

In some implementations, the output driver 114 includes an accelerated processing device (“APD”) 116. In some implementations, the APD 116 is used for general purpose computing and does not provide output to a display (such as display device 118). In other implementations, the APD 116 provides graphical output to a display 118 and, in some alternatives, also performs general purpose computing. In some examples, the display device 118 is a physical display device or a simulated device that uses a remote display protocol to show output. The APD 116 accepts compute commands and/or graphics rendering commands from the one or more processors 102, processes those compute and/or graphics rendering commands, and, in some examples, provides pixel output to display device 118 for display. The APD 116 includes one or more parallel processing units that perform computations in accordance with a single-instruction-multiple-data (“SIMD”) paradigm. In some implementations, the APD 116 includes dedicated graphics processing hardware (for example, implementing a graphics processing pipeline), and in other implementations, the APD 116 does not include dedicated graphics processing hardware.

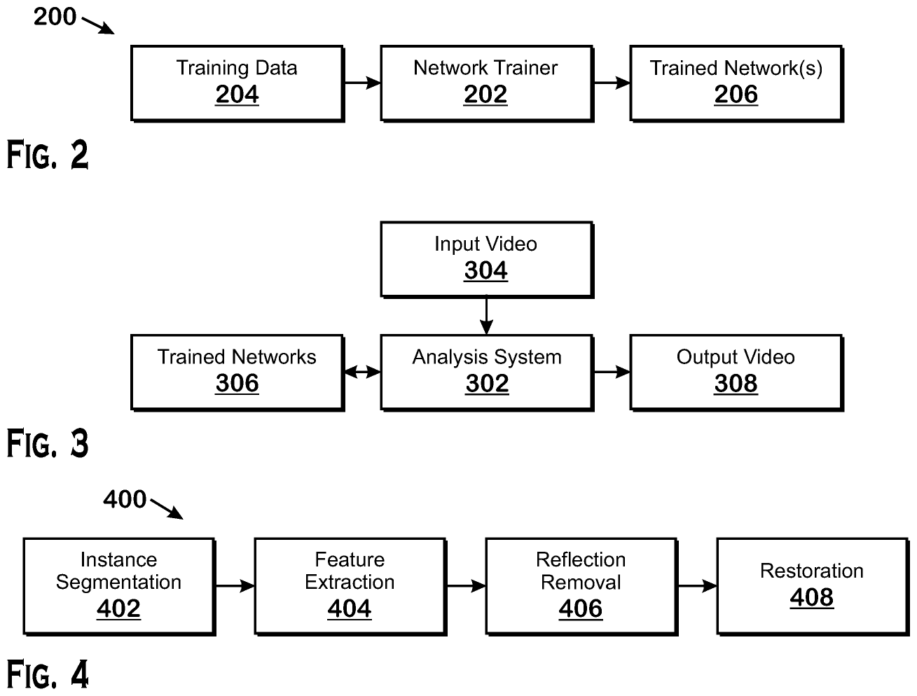

FIG. 2 illustrates a system 200 for training one or more neural networks for analyzing video and removing images from reflections, according to an example. The system 200 includes a network trainer 202, which accepts training data 204 and generates one or more trained neural networks 206.

In various examples, the system 200 is, or is a part of, an instance of the computing device 100 of FIG. 1. In various examples, the network trainer 202 includes software that executes on a processor (such as the processor 102). In various examples, the software resides in storage 106 and is loaded into memory 104. In various examples, the network trainer 202 includes hardware (e.g., circuitry) that is hard-wired to perform the operations of the network trainer 202. In various examples, the network trainer 202 includes a combination of hardware and software that perform the operations described herein. The generated trained neural networks 206 and the training data 204 used to train those neural networks 206 are described in further detail below.

FIG. 3 illustrates a system 300 for analyzing and modifying video to remove reflected images, according to an example. The system 300 includes an analysis system 302 and trained networks 306. The analysis system 302 utilizes the trained networks 306 to identify and remove reflections from input video 304 to generate output video 308. In various examples, the input video 304 is provided to the analysis system 302 via an input source. In various examples, the input source includes software, hardware, or a combination thereof. In various examples, the input source is a separate memory, or is a part of another more general memory such as main memory. In various examples, the input source includes one or more input/output elements (software, hardware, or a combination thereof) configured to fetch the input video 304 from a memory, buffer, or hardware device. In some examples, the input source is a video camera providing frames of video.

In some examples, the system 300 is, or is part of, an instance of the computing device 100 of FIG. 1. In some examples, the computing device 100 that the system 300 is or is a part of is the same computing device 100 as the computing device that the system 200 of FIG. 2 is or is a part of. In various examples, the analysis system 302 includes software that executes on a processor (such as the processor 102). In various examples, the software resides in storage 106 and is loaded into memory 104. In various examples, the analysis system 302 includes hardware (e.g., circuitry) that is hard-wired to perform the operations of the analysis system 302. In various examples, the analysis system 302 includes a combination of hardware and software that perform the operations described herein. In some examples, one or more of the trained networks 306 of FIG. 3 are the same as one or more of the neural networks 206 of FIG. 2. In other words, the system 200 of FIG. 2 generates trained neural networks that are used by the analysis system 302 to analyze and edit video.

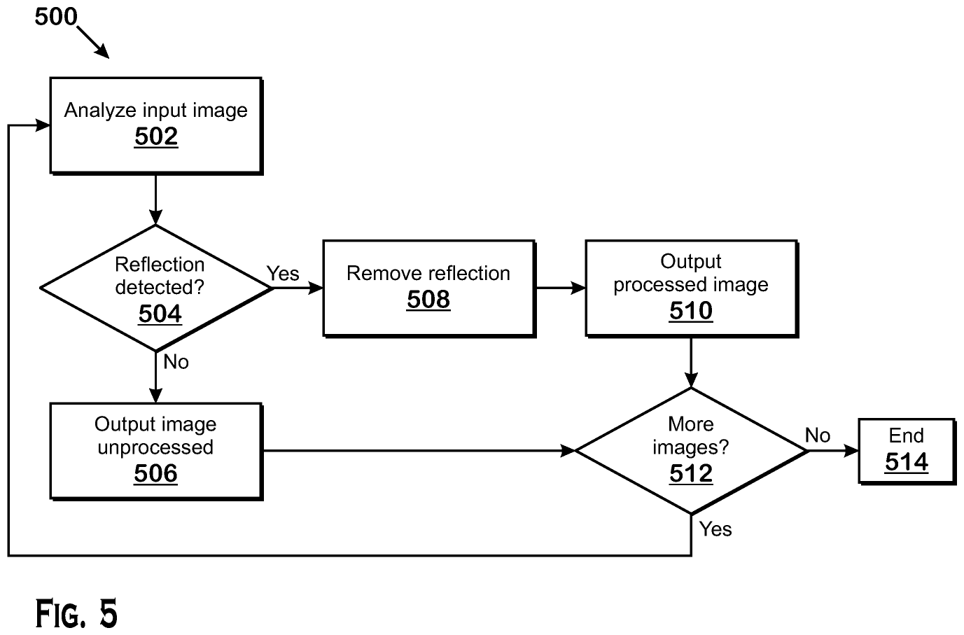

FIG. 4 is a block diagram illustrating an analysis technique 400 performed by the analysis system 302, according to an example. The technique 400 includes an instance segmentation operation 402, a feature extraction operation 404, a reflection removal operation 406, and a restoration operation 408. The analysis system 302 applies the operations of this technique to one or more frames of the input video 304.

The instance segmentation operation 402 identifies portions of an input frame that include a reflection. In one example, at least part of the instance segmentation operation 402 is implemented as a neural network. The neural network is configured to recognize reflections in images. This neural network is implementable as any neural network architecture capable of classifying images. One example neural network architecture is a convolutional neural network-based image classifier. In other examples, any other type of neural network is used to recognize reflections in images. In some examples, an entity other than a neural network is used to recognize reflections in images. In some examples, the neural network utilized at operation 402 is generated by the system 200 of FIG. 2 and is one of the trained neural networks 206. In an example, the system 200 of FIG. 2 accepts labeled inputs including images that either contain or do not contain reflections. For images that contain reflections, the images are labeled with an indication that the image includes a reflection. For images that do not contain reflections, the images are labeled with an indication that the image does not include a reflection. The neural network learns to classify input images as either containing or not containing reflections.

In some implementations, the instance segmentation operation 402 restricts image classification processing to a portion of images input to the system 400. More specifically, in some implementations, the instance segmentation operation 402 obtains an indication of a region of interest, which is a portion of the entire extent of the images being analyzed. In an example, the region of interest is a central portion of the image. In some implementations or modes of operation, the region of interest is indicated by a user. In such implementations, the instance segmentation operation 402 receives such an indication from the user or from data stored in response to a user entering such information. In some examples, the user information is entered in video conferencing software or other video software that performs the technique 400. Often, reflections showing sensitive information are restricted to a certain region of video such as the central portion or other portion.

In some implementations, the instance segmentation 402 includes a two-part image recognition. In a first part, the instance segmentation 402 classifies the image as either having or not having particular types of reflective objects, examples of which include glasses or mirrors. In some examples, this part is implemented as a neural network classifier trained with images containing or not containing such objects and labeled as such. In the event that instance segmentation 402 determines that one of such objects is included in the region of interest, the instance segmentation 402 proceeds to the second part. In the event that the instance segmentation 402 determines that no such object is included within the region of interest, the instance segmentation 402 does not proceed to the second part and does not further process the input image (i.e., does not continue to operations 404, 406, or 408). In a second part, the instance segmentation 402 classifies the image as either including or not including a reflection. Again, in some examples, this part is implemented as a neural network classifier trained with images containing or not containing reflections and labeled as such. In the event that the image does not contain a reflection, the technique 400 does not further process the image (does not perform operations 404, 406, or 408).

The feature extraction operation 404 extracts the portions of the images that contain the reflections. In an example, the feature extraction operation 404 performs a crop operation on the image to extricate the portion of the image containing the reflection. In another example, the feature extraction operation 402 generates an indication of the boundary of the reflection, and this boundary is subsequently used to process the reflection and the image. In some examples, the portion of the image that contains the reflections is the region of interest mentioned with respect to operation 402.

The reflection removal operation 406 removes the reflected images from the extracted portions of the images of operation 404. In an example, the reflection removal operation 406 is implemented as a deconvolution-based neural network-like architecture. In some examples, this neural network is one of the trained neural networks 206 and is generated by the network trainer 202. In an example, the residual neural network attempts to identify learned image features, where the learned features are reflections in a reflective surface. In other words, the residual neural network is trained to recognize portions of an image that are reflected images in a reflective surface. (In various examples, this training is done by the network trainer 200 of FIG. 2). The reflection removal operation 406 then subtracts the recognized feature from the extracted portions to obtain an image of the reflective surface that does not include the reflected images. The output of the reflection removal operation 406 is an image portion having reflections removed.

The restoration operation 408 recombines the image portion having reflections removed with the original image from which the feature extraction operation 404 extracted the image portion in order to generate a frame having reflection removed. In an example, the restoration operation 408 includes replacing the pixels of the original image that correspond to the extracted portion with the pixels processed by operation 406 to remove the reflection features. In an example, the image includes a mirror and the reflection removal operation 406 removes the reflected images within the mirror to generate an image portion having reflections removed. The restoration operation 408 replaces the pixels of the original frame corresponding to the mirror with the pixels as processed by the removal operation 406 to generate a new frame having a mirror with no reflections.

FIG. 5 is a flow diagram of a method 500 for removing reflections from video or images, according to an example. Although described with respect to the system of FIGS. 1-4, those of skill in the art should recognize that any system, configured to perform the steps of the method 500 in any technically feasible order falls within the scope of the present disclosure.

At step 502, the analysis system 302 analyzes the input image 502 to determine whether there are one or more reflections in the input image 502. In some examples, step 502 is performed as step 402 of FIG. 4. More specifically, the analysis system 302 applies the image to a trained neural network, such as a convolutional neural network, which is trained to recognize images having reflections. The result of this application is an indication of whether the image includes a reflection.

At step 504, if the analysis system 302 determines that the image includes a reflection, then the method 500 proceeds to step 508, and if the analysis system 302 determines that the image does not include a reflection, then the method 500 proceeds to step 506, where the analysis system 302 outputs the image unprocessed.

At step 508, the analysis system 302 removes one or more detected reflections. In various examples, the analysis system 302 performs step 508 as steps 404-408 of FIG. 4. Specifically, the analysis system 302 performs feature extraction 404, extracting the portions identified as including a reflection from the image, performs reflection removal 406, removing the reflective features from those portions, and performs restoration 408, replacing the corresponding pixels of the image with pixels of the modified image portions.

At step 510, the analysis system 302 outputs the processed image. In various examples, the output is provided for further video processing or to a consumer of the images, such as an encoder. Step 506 is similar to step 510.

At step 512, the analysis system 302 determines whether there are more images to analyze. In some examples, in the case of a video, the analysis system 302 processes a video frame by frame, removing reflections from each of the frames. Thus in this situation, there are more images to analyze if the analysis system 302 has not processed all frames of the video. In other examples, the analysis system 302 has a designated set of images to process and continues to process those images until all such images are processed. If there are more images to process, then the method 500 proceeds to step 502, and if there are no more images to process, then the method 500 proceeds to step 514, where the method ends.

In various implementations, the processed video output is used in any technically feasible manner. In an example, a playback system processes and displays the video for view by a user. In other examples, a storage system stores the video for later retrieval. In yet other examples, a network device transmits the video over a network for use by another computer system.

It should be understood that many variations are possible based on the disclosure herein. For example, in some implementations, the analysis system 302 is or is part of a video conferencing system. The video conferencing system receives video from a camera and analyzes the video to detect and remove reflected images as described elsewhere herein. Additionally, although certain operations are described as being performed by neural networks or with the help of neural networks, in some implementations, neural networks are not used for one or more such operations. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for removing reflections from images, comprising:
first identifying that a first image includes an object deemed to be a reflective object;
responsive to the first identifying, removing one or more reflections from the first image to generate a modified first image;
second identifying that a second image does not include an object deemed to be a reflective object; and
foregoing processing the second image to remove one or more reflections from the second image.

2. The method of claim 1, wherein the first image comprises a still image.

3. The method of claim 1, wherein the first image comprises a frame of a video conference.

4. The method of claim 3, further comprising:
obtaining video from a camera of a video conferencing system;
analyzing the video to generate modified video; and
transmitting the video to a receiver of the video conferencing system,
wherein the analyzing includes the first identifying, the removing, the second identifying, and the foregoing, and the modified video includes the first image with one or more reflections removed and the second image.

5. The method of claim 1, further comprising transmitting the modified first image and the second image to a display.

6. The method of claim 5, wherein identifying that the first image includes the object deemed to be a reflective object comprises processing the first image with a classifier configured to identify images as either including objects deemed to be reflective or as not including objects deemed to be reflective.

7. The method of claim 6, wherein the classifier includes a neural network classifier.

8. The method of claim 1, wherein identifying that the first image includes an object deemed to be a reflective object comprises searching for the object within a region of interest of the first image.

9. The method of claim 1, wherein second identifying that a second image does not include an object deemed to be a reflective object comprises determining that the second image does not include the object within a region of interest of the second image.

10. A system for removing reflections from images, the system comprising:
an input source; and
an analysis system configured to:
retrieve a first image and a second image from the input source;
perform first identifying that the first image includes an object deemed to be a reflective object;
responsive to the first identifying, remove one or more reflections from the first image;
perform second identifying that the second image does not include an object deemed to be a reflective object; and
forego processing the second image to remove one or more reflections from the second image.

11. The system of claim 10, wherein the first image comprises a still image.

12. The system of claim 10, wherein the first image comprises a frame of a video conference.

13. The system of claim 12, wherein:
the input source comprises a camera of a video conferencing system; and
the analysis system is further configured to:
obtain video from a camera of a video conferencing system;
analyze the video to generate modified video; and
transmit the video to a receiver of the video conferencing system,
wherein the analyzing includes the first identifying, the removing, the second identifying, and the foregoing, and the modified video includes the first image with one or more reflections removed and the second image.

14. The system of claim 10, wherein the analysis system is further configured to output the modified image and the second image for display.

15. The system of claim 14, wherein identifying that the first image includes the object deemed to be a reflective object comprises processing the first image with a classifier configured to identify images as either including objects deemed to be reflective or as not including objects deemed to be reflective.

16. The system of claim 15, wherein the classifier includes a neural network classifier.

17. The system of claim 10, wherein identifying that the first image includes an object deemed to be a reflective object comprises searching for the object within a region of interest of the first image.

18. The system of claim 10, wherein second identifying that a second image does not include an object deemed to be a reflective object comprises determining that the second image does not include the object within a region of interest of the second image.

19. A non-transitory computer-readable medium storing instructions that, when executed by a processor, cause the processor to perform operations comprising:
first identifying that a first image includes an object deemed to be a reflective object;
responsive to the first identifying, removing one or more reflections from the first image;
second identifying that a second image does not include an object deemed to be a reflective object; and
foregoing processing the second image to remove one or more reflections from the second image.

20. The non-transitory computer-readable medium of claim 19, wherein the first image comprises a still image.
